(19) United States
(12) Patent Application Publication
(10) Pub. No.: US 2026/0103236 A1
(43) Pub. Date: Apr. 16, 2026

(54) VEHICULAR DRIVING ASSIST SYSTEM

(71) Applicant: Magna Electronics Inc., Auburn Hills, MI (US)

(72) Inventors: Arpit Awathe, Rochester Hills, MI (US); Tejas Murlidhar Varunjikar, Troy, MI (US); Arihant Jain, Auburn Hills, MI (US)

(21) Appl. No.: 19/353,807

(22) Filed: Oct. 9, 2025

Related U.S. Application Data
(60) Provisional application No. 63/706,150, filed on Oct. 11, 2024.

(51) Int. Cl. B62D 6/00; B62D 15/02

(52) U.S. Cl. CPC B62D 6/001; B62D 15/0255

(57) ABSTRACT

A vehicular driving assist system includes a camera disposed at a vehicle. The vehicular driving assist system, at least in part processing of image data captured by the camera, determines a target path of travel ahead of the vehicle. The vehicular driving assist system determines vehicle state information from a respective vehicle state source of a plurality of vehicle state sources of the vehicle based at least in part on a current environmental condition at the vehicle The vehicular driving assist system estimates curvature of a current trajectory of travel of the vehicle based at least in part on the determined vehicle state information.

### CROSS REFERENCE TO RELATED APPLICATION

The present application claims the filing benefits of U.S. provisional application Ser. No. 63/706,150, filed Oct. 11, 2024, which is hereby incorporated herein by reference in its entirety.

### FIELD OF THE INVENTION

The present invention relates generally to a vehicle sensing system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driving assist system includes a camera disposed at a vehicle equipped with the vehicular driving assist system and viewing exterior of the vehicle. The camera is operable to capture image data. The system includes an electronic control unit (ECU) with electronic circuitry and associated software. Image data captured by the camera is transferred to the ECU. The electronic circuitry of the ECU includes an image processor, and the image processor is operable to process image data captured by the camera and transferred to the ECU. The vehicular driving assist system, at least in part via processing at the ECU of image data captured by the camera and transferred to the ECU, determines a target path of travel ahead of the equipped vehicle along a road on which the equipped vehicle is traveling. The vehicular driving assist system determines vehicle state information from a respective vehicle state source of a plurality of vehicle state sources of the equipped vehicle based at least in part on a current environmental condition at the equipped vehicle. The vehicular driving assist system estimates curvature of a current trajectory of travel of the equipped vehicle based at least in part on the determined vehicle state information.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensing system that incorporates cameras;

FIG. 2 is a block diagram of the sensing system of FIG. 1;

FIG. 3 is a diagram of a kinematic bicycle model for determining vehicle curvature;

FIG. 4 is a diagram of an Ackermann steering model for determining vehicle curvature;

FIG. 5 is an image of a road profile for lane centering feature testing;

FIGS. 6-10 are plots of curvature outputs for various curvature estimation techniques; and

FIGS. 11-15 are plots of lateral offsets for the scenarios in FIGS. 6-10.

### DESCRIPTION OF THE PREFERRED EMBODIMENTS

Advanced Driver Assistance Systems (ADAS) lateral feature performance, such as for a lane centering assist feature, may be influenced by inputs from the surroundings and vehicle state information or signals. A significant piece of vehicle state information may be the curvature of the current path or trajectory of the vehicle equipped with the ADAS, which can substantially impact performance. The curvature of the equipped vehicle (i.e., the amount or degree of turning by the vehicle at any given time) is often used as an input for lateral trajectory generation and may also be a component of the lateral motion controller. However, obtaining accurate vehicle curvature or steering data can be complex, as there is rarely a sensor that directly measures this parameter. Instead, curvature is typically derived from various vehicle signals and additional sensor data, often employing sophisticated estimation techniques.

Implementations herein consider the impact on lateral feature performance when vehicle curvature is estimated from different source signals. The implementations take into account the issues and benefits associated with various techniques for determining vehicle curvature and optimizing lateral feature performance.

A vehicle sensing system vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

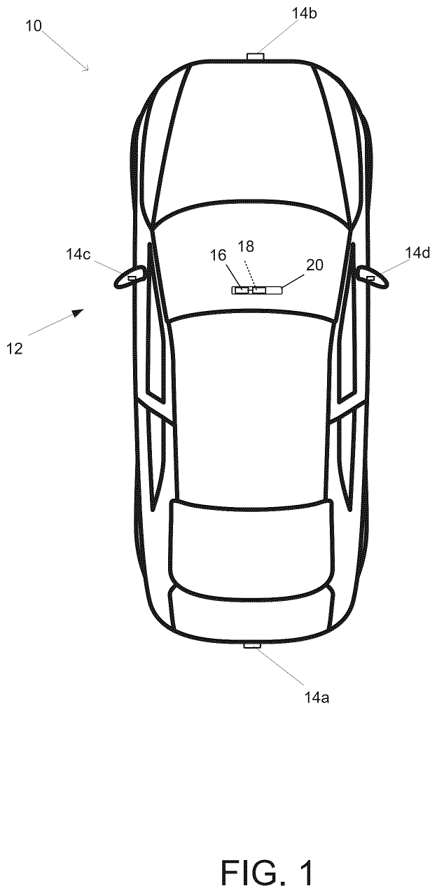

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). Optionally, the vehicle includes other sensors, such as one or more radar sensors, lidar sensors, ultrasonic sensors, etc. The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

The lateral ADAS features are designed to align the vehicle equipped with the ADAS features with a reference line. The reference line may represent the center of the lane for lane centering assist, the center of an adjacent lane for lane change assist, or another designated position depending on the active lateral feature, such as in the case of Evasive Maneuvering Assist. During these dynamic maneuvers, the lateral features are designed and calibrated to operate such that parameters like lateral acceleration and lateral jerk do not exceed specific thresholds, which are intended to enhance passenger comfort and, in some cases, comply with regulatory requirements. Furthermore, these features may fulfill predefined performance criteria, including overshoot and steady-state error. Performance metrics, such as Integral of Absolute Error (IAE) and Maximum Lateral Error (MLE), may be utilized for the comparative analysis of the lane centering feature.

The lane centering feature may utilize vehicle data relative to the reference line, such as vehicle offset, heading error, derivatives of vehicle offset and/or heading error, and the curvature of the reference lane. Additionally or alternatively, the lane centering feature may also utilize vehicle states, such as the curvature and velocity of the equipped vehicle, to generate a steering angle command that is determined to guide the equipped vehicle along the reference line. Implementations herein may include a comprehensive analysis of a Model Predictive Control (MPC) strategy for lateral control using such data. Similarly, different lateral control methodologies, including path tracking through Geometric, Kinematic, and Dynamic Models, may be incorporated using comparable data inputs.

In other examples, lane centering features may generate one or more trajectories that direct movement from an initial point to a final point, aligning the vehicle with the reference line upon completion. Trajectory generation may improve smoothness of vehicle curvature as the vehicle navigates transitions in the curvature of the road, such as a transition from a left curve to a right curve. In further examples, trajectory generation may include higher-order polynomial trajectories, clothoids, and splines. Additionally or alternatively, the lane centering feature may perform geometric path generation techniques, such as Stanley and pure pursuit controllers. The lane centering feature may determine vehicle offset and heading errors relative to the trajectory rather than the reference line. The lane centering feature may generate a steering angle command based at least in part on the curvature of the trajectory and vehicle states, such as vehicle curvature and velocity.

In some implementations, the curvature of the reference line or the trajectory may function as a feedforward component for the ADAS and/or the lane centering feature. In such implementation, the curvature of the equipped vehicle aligns with either the reference line or the trajectory curvature. Furthermore, in trajectory generation techniques, the curvature of the equipped vehicle is utilized as an input to determine the trajectory. Thus, accurate data regarding the curvature of the vehicle improves the performance of lateral control features, such as the lane centering feature.

Techniques for estimating the curvature of the vehicle remain limited, and vehicular sensors that directly measure the curvature of the vehicle are typically not available. Estimating the curvature of the equipped vehicle or the turn radius of the vehicle may be determined via vehicle state information, such as yaw rate, steering angle, lateral acceleration, and/or individual wheel speeds of the vehicle, and/or GPS data (e.g., global positioning coordinates). Two distinct approaches may be used to determine curvature of the vehicle based on steering angle of the vehicle: (i) an Ackermann steering model and (ii) a kinematic bicycle model. Curvature estimation based on Global positioning coordinates, yaw rate, lateral acceleration, or steering angle of the equipped vehicle may include errors in the curvature estimation when compared to curvature estimation based on ground truth, which may affect performance of lateral control features of the vehicle.

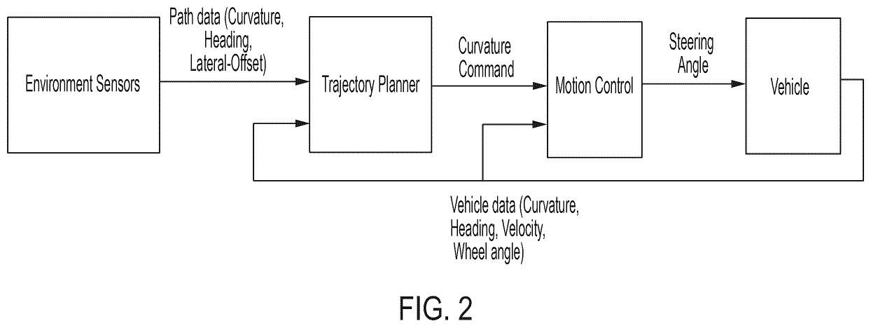

Referring now to FIG. 2, the lane centering feature may incorporate inputs from the environment, such as lane information provided by cameras (e.g., in the form of image data). Additionally or alternatively, the system may receive data from vehicle sensors to determine vehicle states (e.g., accelerometers). From the image data and the sensor data, the lane centering feature may receive curvature, heading, lateral-offset data, and/or other path data. The path data is processed by a trajectory planner module to determine a reference trajectory. Optionally, the trajectory planner module may determine a curvature command to guide the vehicle based on the path data. A lateral control module and/or a motion control module utilizes the reference trajectory to generate a steering angle command. As the vehicle adjusts the steering angle responsive to the steering angle command, the lane centering feature may receive vehicle data as feedback, such as vehicle curvature, heading, velocity and/or vehicle speed, and wheel angle. The vehicle data feedback may be received at the trajectory planner module and/or the motion control module to determine error in the vehicle trajectory and update the curvature command and/or the steering angle command to reduce the error. Performance of the lane centering feature may be significantly influenced by the implementation of the lane centering algorithm of FIG. 2. For example, trajectory planning and motion control of the algorithm may affect lane centering performance.

The trajectory planner module utilizes a current pose and an intended final pose of the equipped vehicle to align with the reference line and generate a reference trajectory. In some examples, the generated reference trajectory may be represented using a fifth-order polynomial to ensure continuity in offset, heading, and curvature. The trajectory planner module may determine a horizon time at which the offset, heading, and curvature of the vehicle may align with the offset, heading, and curvature of the reference line. The final pose may be determined by evaluating the reference line at a target distance associated with the horizon time.

After determining the reference trajectory to transition from the current vehicle pose to the intended final pose at the horizon time, a desired vehicle curvature is determined. In some examples, determining the desired curvature may include defining a look-ahead time and selecting a curvature value of the reference trajectory at that moment. Due to system dynamics, a delay may exist between the desired curvature and the actual curvature of the equipped vehicle. Thus, a look-ahead time that approximates the delay may be determined to compensate for the delay. In some examples, other trajectory information, such as lateral position error and heading error, may be used to compensate for the delay.

A curvature control module utilizes a wheelbase of the vehicle (L) and an understeer gradient (K_{US}) to convert a desired curvature (κ_{d}) into a steering angle command (δ_{d}) based on the vehicle speed (v) to guide the equipped vehicle along the reference trajectory such that the vehicle aligns with the reference line at the horizon time. The curvature control module may also utilize a feedback term to reduce the difference between the reference trajectory and the reference line at the horizon time. Accordingly, a proportional-integral-derivative (PID) controller may be implemented to correct curvature error (eₖ) between the desired curvature (κ_{d}) and actual curvature (κ) of the equipped vehicle. Here, eₖ=κ_{d}−κ, and K_{P}, K_{D}, and K_{I} represent the proportional, derivative, and integral gains, respectively. This relationship is shown in Equation (1), below.

$${δ}_{d} = ( L + {K}_{US} \cdot v ) {κ}_{d} + ( {K}_{P} \cdot {e}_{κ} + {K}_{D} {e}_{\dot{κ}} + {K}_{I \int {e}_{κ}} ) \qquad ( 1 )$$

Actual curvature (κ) measures how a current trajectory of the vehicle deviates from traveling straight, i.e., how sharply it is turning. is defined as the rate of change of the heading angle (dθ) of the vehicle relative to the distance traveled (dx). The radius of curvature, R, is the reciprocal of actual curvature (k), as represented by Equation (2), below.

$$κ = d θ / dx = 1 / R \qquad ( 2 )$$

When accurate information about the path of the vehicle is available, the curvature of the equipped vehicle can be calculated precisely. However, most vehicles may lack precise path information. In examples where precise path information is not available, alternative data may be used to estimate actual curvature (k), such as yaw rate (yᵣ), lateral acceleration (a_{y}), steering angle (δ), or individual wheel speeds (wₗ for the left front wheel and wᵣ for the right front wheel). Optionally, the wheel speed of the rear wheel may also be used to estimate actual curvature (k).

Yaw rate (yᵣ) (i.e., the rate of change of heading of the vehicle with respect to time (t)) may be captured by an inertial measurement unit (IMU) sensor. Yaw rate (yᵣ) may be represented as a derivative of the heading angle (θ) with respect to time (t), as shown in Equation (3), below.

$${y}_{r} = d θ / dt \qquad ( 3 )$$

The relationship between yaw rate (yᵣ) and the actual curvature (k) of the equipped vehicle, given the vehicle speed (v), is represented by Equation (4), below.

$${y}_{r} = ( d θ / dt ) * ( dx / dx ) = κ * v \qquad ( 4 )$$

Noise in the IMU sensor may reduce the accuracy of actual curvature (k) estimations. Filters may reduce this noise but may also increase delay in actual curvature (k) estimation relative to the ground truth. Determining actual curvature (k) based on yaw rate (yᵣ) and vehicle speed (v) may be less accurate in conditions where the vehicle is slipping (i.e., where the vehicle has loss of traction), oversteering, or understeering, as the yaw rate (yᵣ) may not reflect the actual turning radius (R) of the vehicle. Determining actual curvature (k) based on yaw rate (yᵣ) and vehicle speed (v) may also be less accurate at low speeds, as yaw rate (yᵣ) is divided by vehicle speed (v) to determine the actual curvature (k). Conversely, determining actual curvature (k) based on yaw rate (yᵣ) and vehicle speed (v) may be more accurate at higher speeds.

Steering angle (δ) is a primary input that may be used to determine actual vehicle curvature (k). Actual curvature (k) may be estimated based on a relationship between steering angle (δ) and yaw rate (yᵣ). In some examples, specific assumptions may be made to proportionally relate the curvature of the equipped vehicle (k) to the steering angle (δ), as shown in Equation (5), below, where i_{sg} represents a steering gear ratio of the vehicle, and L represents the wheelbase.

$$κ = δ / ( {i}_{sg} * L ) \qquad ( 5 )$$

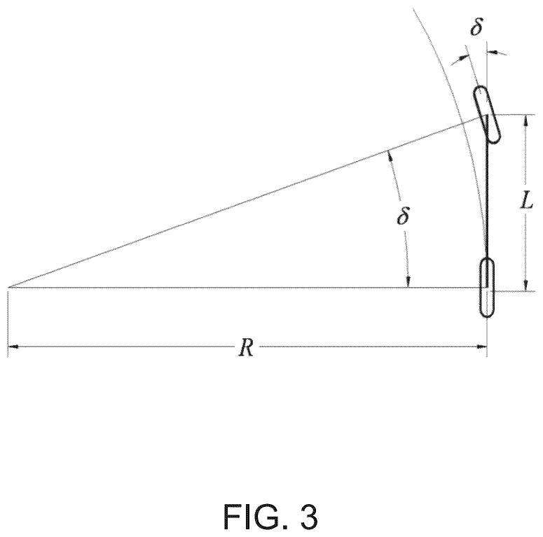

More accurate equations representing the relationship between steering angle (δ) and actual curvature (k) may be produced using higher-order models that account for vehicle dynamics. For instance, Equation (5) does not consider vehicle slip or cornering stiffness and assumes a four-wheel vehicle behaves like a two-wheel bicycle model (i.e., a kinematic bicycle model), which can lead to inaccurate estimations. FIG. 3 illustrates an example diagram of the two-wheel bicycle model.

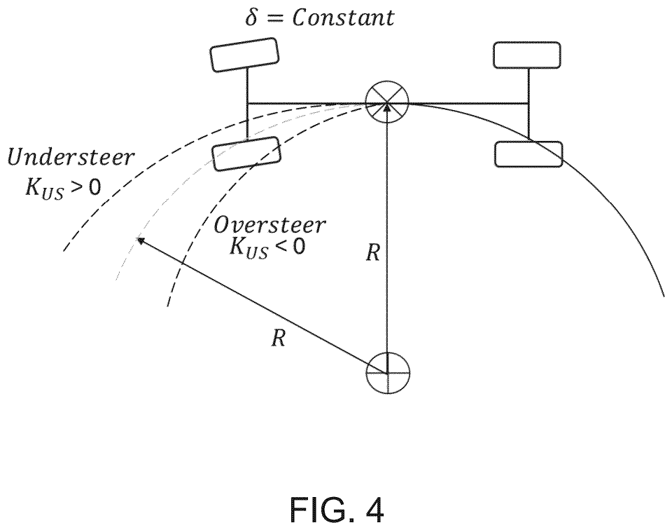

Methods, such as the Ackermann steering model (FIG. 4), may be used to estimate the curvature of the equipped vehicle. However, the Ackermann steering model may yield unstable results due to crosswinds and road camber conditions. The Ackermann steering model also does not account for steering frequency, which can affect curvature estimation. At high steering frequencies, the amplitude of the curvature may decrease due to rapid steering input. The Ackermann steering model does not adapt to varying frequencies, resulting in similar outputs regardless of the steering frequency. Moreover, accurate curvature estimation includes accounting for steering bias, which must also be estimated.

The Ackermann steering model is particularly effective at low speeds, as it does not use vehicle speed (v) as input. The estimation of the curvature of the equipped vehicle is based directly on the input steering angle (δ), reducing computational delay compared to methods that use yaw rate (yᵣ), lateral acceleration (a_{y}), or other sensors requiring additional processing steps.

To improve the relationship between steering angle (δ) and actual vehicle curvature (k), additional vehicle dynamics parameters may be considered, including vehicle speed (v) and the understeer gradient (k_{US}), which is a rate of change of understeer angle with respect to lateral acceleration (a_{y}). This improved relationship is represented by Equation (6), below.

$$κ = {δ}_{ack} / ( L + {K}_{US} \cdot {v}^{2} ) \qquad ( 6 )$$

The Ackermann steering model is similar to determining actual curvature (k) based on steering angle (δ), but the Ackermann steering model may be more accurate on curved roads and at higher vehicle speeds (v), particularly during significant lateral acceleration (a_{y}) in turns. As with determining actual curvature (k) based on steering angle (δ), the Ackermann steering model does not account for transient road curvatures (e.g., changes in turn radius or direction).

In the context of the curvature (k) of the equipped vehicle using lateral acceleration (a_{y}), lateral acceleration (a_{y}) represents the rate of change of velocity of the vehicle in the lateral direction (i.e., the second derivative of lateral position) based on rotational dynamics. The relationship between lateral acceleration (a_{y}) and the curvature (k) of the equipped vehicle may be represented by Equation (7), below.

$$κ = \frac{{a}_{y}}{{v}^{2}} \qquad ( 7 )$$

Determining curvature (k) based on lateral acceleration (a_{y}) may be effective in the presence of crosswinds and/or when there is a difference in turning radius between the left wheel and the right wheel. However, determining curvature (k) based on lateral acceleration (a_{y}) may become unstable at low vehicle speeds (v) and/or on roads with significant camber. Additionally, sensor noise can affect the accuracy of the curvature determination. After processing the sensor measurements to remove noise, delays may degrade curvature estimation.

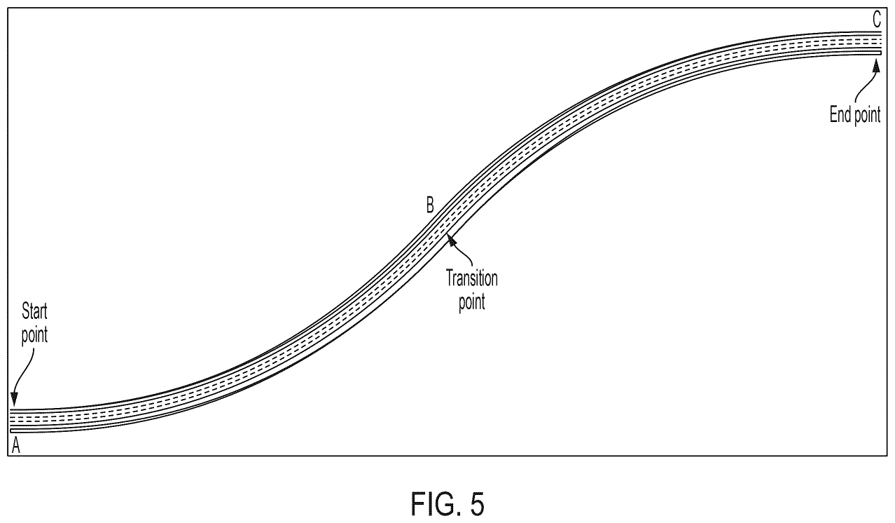

The lane centering feature described herein may be used in a vehicle to determine curvature (k) of the vehicle across various driving scenarios and conditions. Each of the curvature estimation techniques described above may be utilized by the lane centering feature to yield a different curvature estimation based on the driving scenarios and conditions. The methods and systems described herein disclose a lane centering feature for use in a vehicle to determine curvature (k) of the vehicle across various driving scenarios and conditions. An example road profile characterized by an S-curve is provided to demonstrate the differing performance of each curvature estimation technique. As illustrated in FIG. 5, the S-curve of the road profile has a left constant-radius curve followed by a right constant-radius curve. The road profile begins at point A, where the constant radius curve on the left starts. The left curve is followed by the transition point B, where the curvature changes from left to right, and the right curve ends at point C.

In some examples, the road profile may include variations in camber and grade, as well as variations in environmental conditions, such as wind. The variations reflect various driving environments that may affect the lane centering feature. In all examples, the vehicle is operating at a constant vehicle speed (v) of fifty (50) miles per hour (MPH).

Different techniques of equipped vehicle curvature estimation—such as yaw rate, steering angle, the Ackermann steering formula, and lateral acceleration—may result in different vehicle headings and lateral offsets from the reference line. An actual ground truth curvature of the equipped vehicle, which may be calculated in simulation software, is incorporated as a baseline. The estimated curvature data produced by the curvature estimation techniques serves as input for the vehicle controller in closed-loop operation of the lane centering feature.

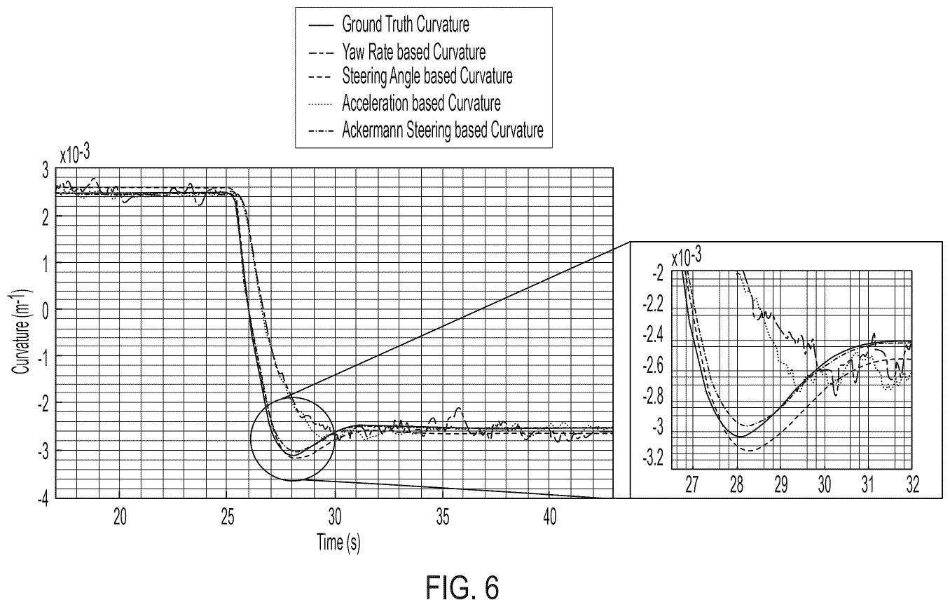

FIG. 6 illustrates estimated vehicle curvatures using four estimation techniques alongside the ground truth curvature in a first example in which the road profile includes the S-curve without any variation in grade and camber. The zoomed-in region corresponds to transition point B. The yaw rate and lateral acceleration-based estimations may produce oscillations due to noise in the yaw rate (yᵣ) and the lateral acceleration (a_{y}) measurement sensor, with peaks damped and shifted via filtering. The curvature estimation based on steering angle (δ) may overestimate the actual curvature (k) and maintain a constant offset throughout the test, while the Ackermann steering angle-based estimation may be closer to the ground truth under steady-state conditions but may underestimate the actual curvature (k) at transition point B.

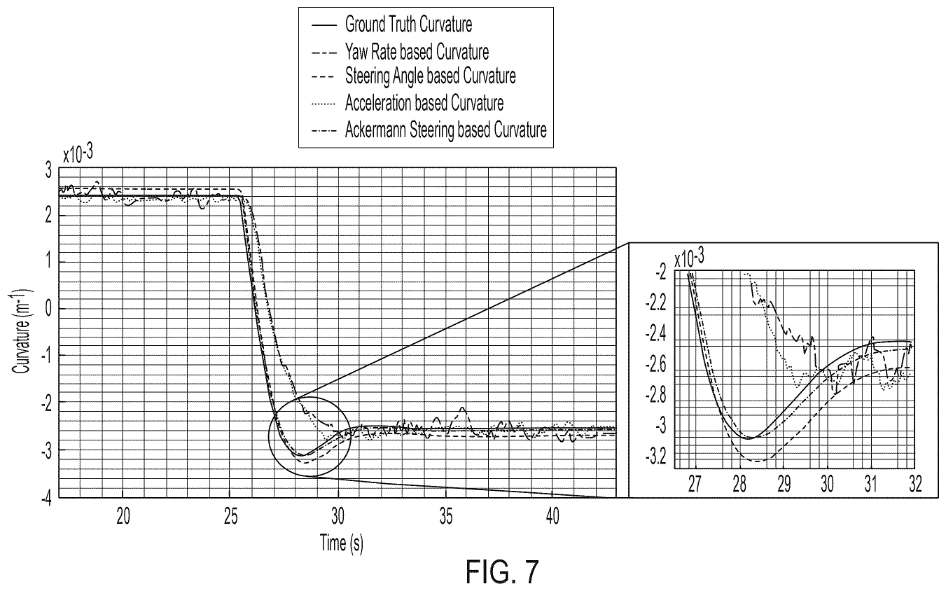

FIG. 7 illustrates estimated vehicle curvatures using the four estimation techniques alongside the ground truth curvature in a second example in which a road grade of five percent (5%) is introduced. Due to the road grade, the steering angle required to follow the curves of the road profile will differ from the road profile of FIG. 6. This can reduce accuracy of curvature estimations that use solely steering angle for curvature estimation. The curvature estimates here may be similar to those in the first example. However, the steering angle-based curvature estimation may show a higher overshoot at transition point B than in the first example.

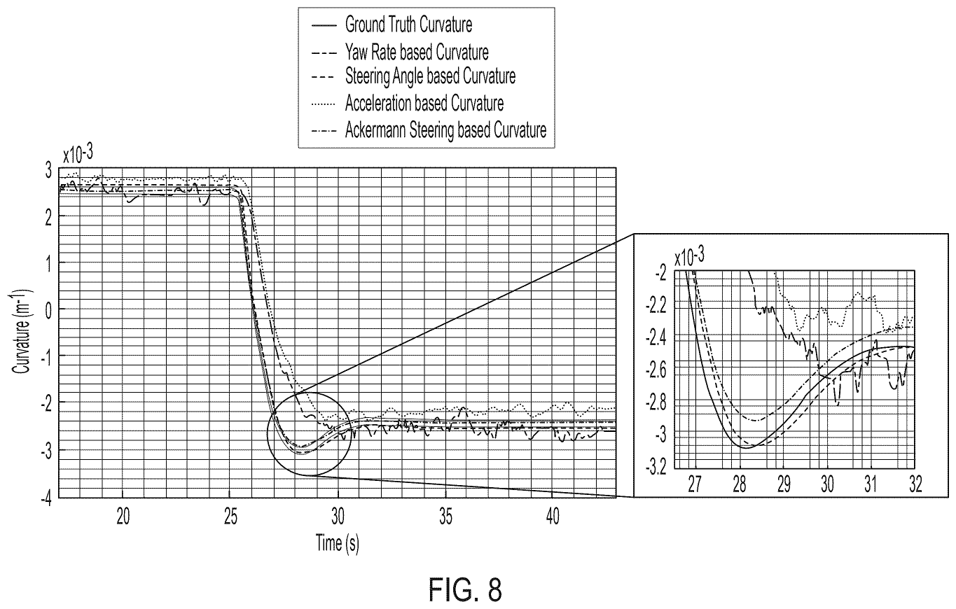

FIG. 8 illustrates estimated vehicle curvatures using the four estimation techniques alongside the ground truth curvature in a third example in which a road camber of two percent (2%) is introduced. Here, the lateral acceleration-based curvature estimation may deviate from the ground truth. The road camber alters the impact of gravitational force on the vehicle, which is reflected in the lateral acceleration measurement. Thus, the lateral acceleration signal for curvature estimation may result in increased inaccuracies, producing a deviation from the ground truth curvature.

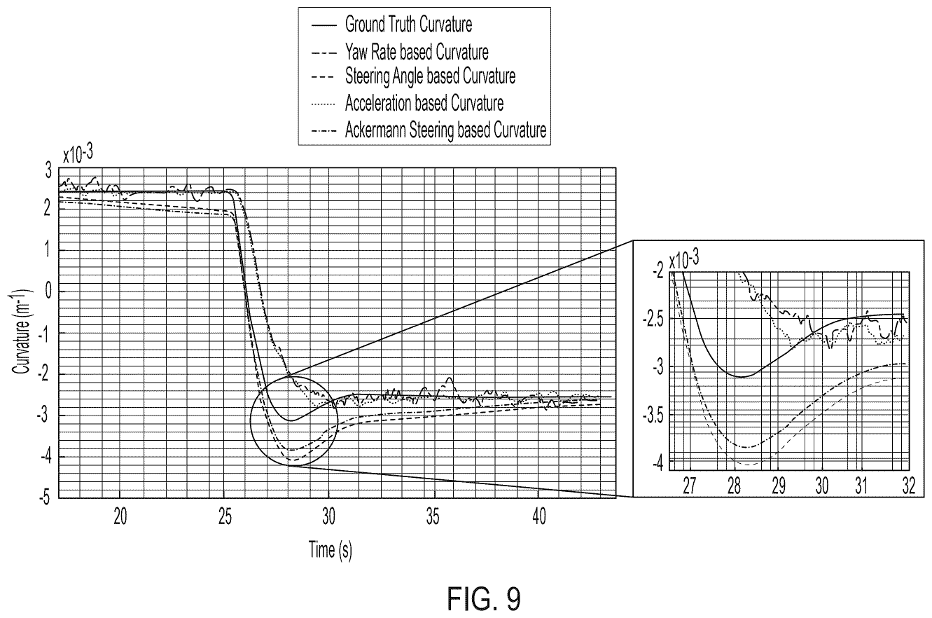

FIG. 9 illustrates estimated vehicle curvatures using the four estimation techniques alongside the ground truth curvature in a fourth example in which high wind conditions are introduced (e.g., winds of 46.6 MPH). The yaw rate and the lateral acceleration-based curvature estimates may be similar to those in the first example. The steering angle and the Ackermann steering-based estimates may result in deviations from the ground truth in both steady states and transient states. The deviations may produce either underestimated or overestimated curvature based on wind direction. In high-wind scenarios, lateral forces exerted on the vehicle, such as at the tires, can lead to a non-zero steering angle that contributes to inaccuracies in curvature estimation.

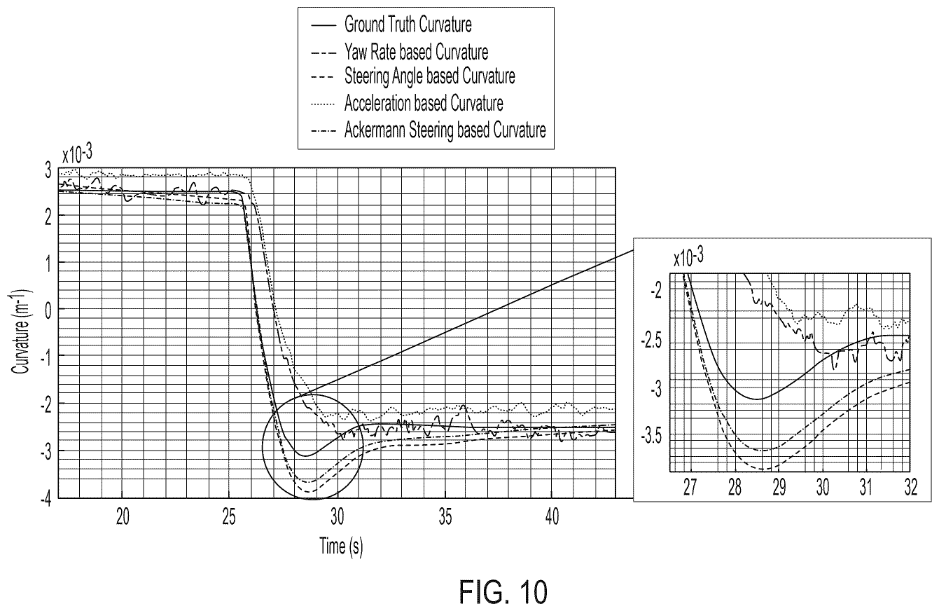

FIG. 10 illustrates estimated vehicle curvatures using the four estimation techniques alongside the ground truth curvature in a fifth example that combines the road grade, camber, and high wind conditions of the previous examples. Each curvature estimation technique may produce deviations from the ground truth similar to the deviations observed in the respective technique due to the individual road parameter variations discussed earlier.

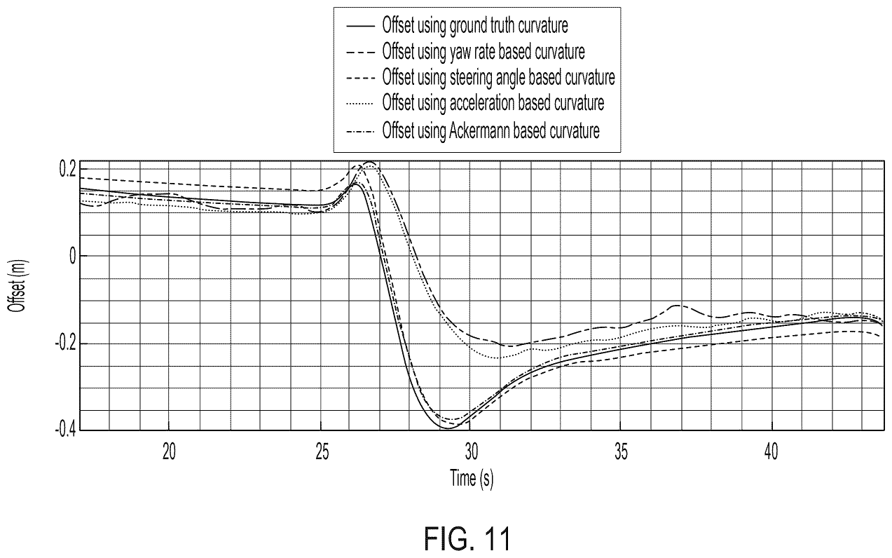

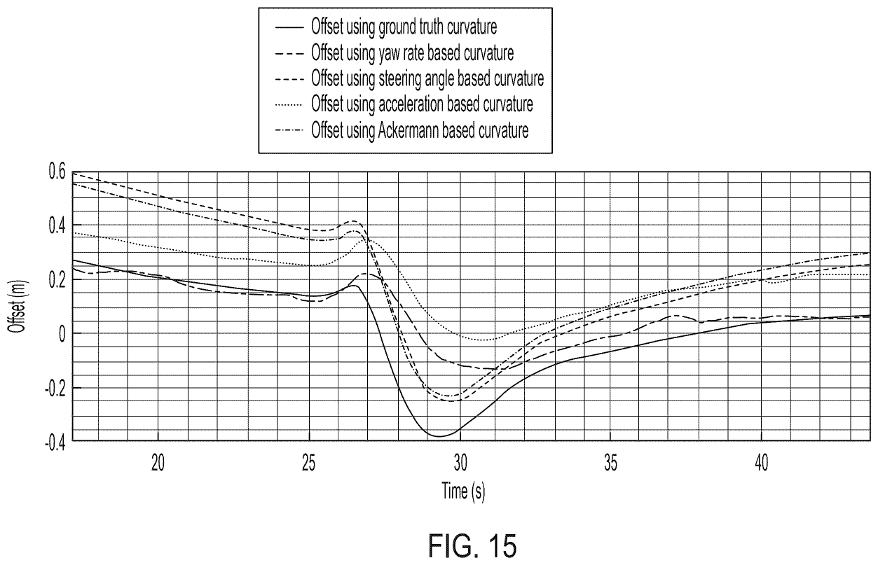

In the above examples, the lane centering feature offsets the equipped vehicle from the lane center, in which each curvature estimation method produces a different lateral offset. FIGS. 11-15 illustrate the lateral offsets associated with the curvature estimations illustrated in FIGS. 6-10, respectively. In the above examples, applying yaw rate curvature estimation to the lane centering feature produces offsets from the lane center that are similar to those observed when using the ground truth curvature as input for the lane centering feature, particularly in steady-state conditions. FIGS. 11-15 illustrate that during steady-state conditions on the curved portions of the road profile, the offsets may be close to those from the ground truth curvature. However, where the road profile transitions from the left curve to the right curve at point B (i.e., a transient road condition), yaw rate-based estimation may exhibit a higher overshoot compared to the ground truth, particularly in FIG. 11, where it shows 0.22 meters versus 0.17 meters.

The higher offset may occur when the road transitions from left to right curve, causing a change in curvature signs. Conversely, when the equipped vehicle is on the right curvature, the overshoot may be less compared to the ground truth when applying yaw rate estimation. For example, in FIG. 11, it is −0.2 meters versus −0.4 meters. This result may be consistent across all scenarios, as seen in FIGS. 11-15. That is, the yaw rate-based curvature may underestimate the curvature, leading to a higher overshoot at the transition point B, and it may demonstrate improved performance after the transition across all scenarios. However, the equipped vehicle may exhibit oscillations from the lane center, resulting in an oscillatory lateral offset. Filtering the yaw rate signal may introduce delays and further oscillations, causing discomfort for passengers.

When the lane centering feature utilizes steering angle-based curvature estimation, vehicle offset from the lane center may be observed, exceeding offsets observed with the ground truth curvature, as illustrated in FIGS. 11-15. Steering angle-based curvature estimation exhibits errors in both steady-state conditions and during transient peaks, resulting in larger offsets from the lane center.

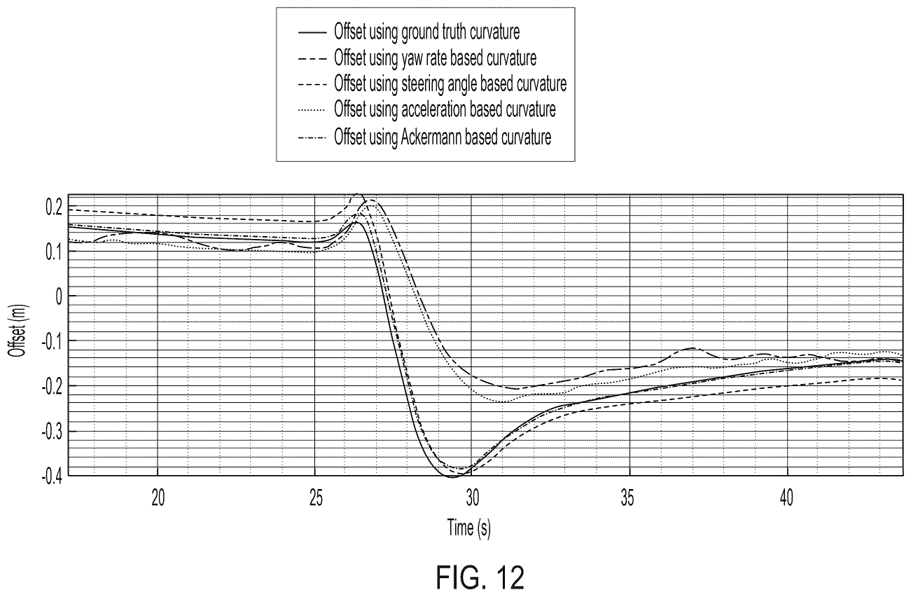

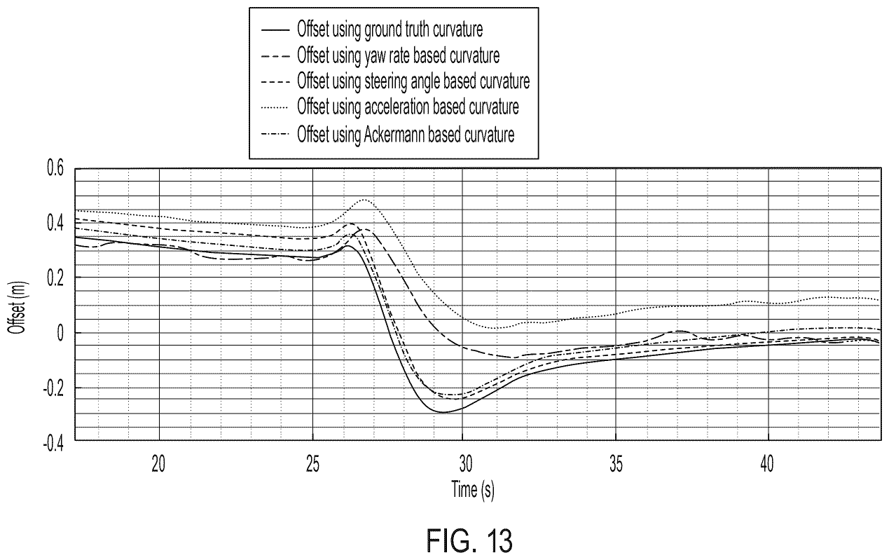

At the transition point B, FIG. 11 illustrates that the overshoot may be up to 0.04 m higher than the ground truth when using steering angle-based estimation. This error arises from the inability of the steering angle-based estimation to account for tire slip, leading to an overestimation of curvature. Similarly, in FIGS. 12 and 13 when road grade and camber are introduced, overshoots of up to 0.06 meters and 0.09 meters higher than the ground truth may result, respectively. In FIG. 12, the introduction of road grade affects the steering angle, which in turn influences the curvature estimation. Although the turning path may remain unchanged regardless of grade, the varying steering angle during turning maneuvers increases the inaccuracy of the curvature estimations. Similarly, in FIG. 13, the addition of road camber amplifies the lateral forces acting on the vehicle. To balance these forces, the steering angle differs from that required on a level road, resulting in inaccuracies in curvature estimation.

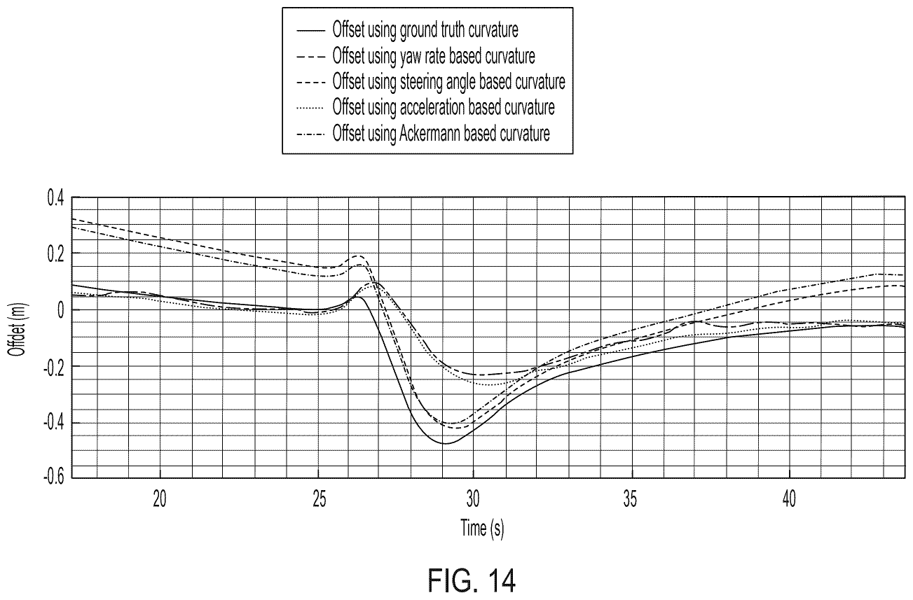

In FIG. 14, where wind effects are considered, the offset resulting from the steering angle-based estimation may increase to 2.3 meters higher than the ground truth. When accounting for all variations, the offset may further rise to 2.5 meters higher than the ground truth at the transition point B. In high wind scenarios, lateral forces exerted on the tires can lead to a non-zero steering angle, contributing to inaccuracies in curvature estimation and resulting in larger offsets from the lane center. The direction of both camber and wind affect the lateral offset. When the direction of camber or wind opposes the lane offset, it can lead to a reduction in the overall lane center offset when the lane centering feature uses the steering angle-based estimation.

The Ackermann steering angle-based curvature estimation, which accounts for tire slip, may reduce lane center offsets compared to steering-based techniques. In some implementations, the Ackermann steering angle-based estimation produces an offset similar to the ground truth curvature during both steady-state and transient road curvature conditions.

The Ackermann steering angle-based estimation may also produce a lateral offset similar to the ground truth when the road is graded (FIG. 12), differing by approximately 0.02 meters at transition points and only 0.01 meters during steady state. This level of accuracy reflects the ability of the Ackermann steering angle-based estimation to better account for vehicle dynamics.

The addition of road camber (FIG. 13) may result in an offset of about 0.04 meters from the ground truth at transition points and 0.03 meters during steady state, representing an improvement over the offsets observed in other steering angle-based curvature estimation techniques. The introduction of wind (FIG. 14) may result in an offset difference of approximately 0.2 meters. Therefore, the Ackermann steering angle-based estimation may still be affected by road camber and wind, which unevenly distribute tire loads and impact grip, leading to inaccuracies in curvature estimation and larger offsets from the lane center.

The lateral acceleration-based curvature estimation produces lane offsets that closely align with the ground truth in steady-state conditions. However, this technique may have an offset up to 0.04 meters higher than the ground truth at the transition point B. A similar offset may be observed in conditions including road grade, road camber, and/or wind.

In some examples, the lateral offset at point B may be 0.17 meters higher than the offset using the ground truth curvature and 0.11 meters higher than the offset using the ground truth curvature during steady state. Thus, road camber may affect lateral offset produced by lateral acceleration-based curvature estimation, as lateral acceleration measurements from an accelerometer are affected by the road camber. Road camber alters weight distribution and alters the impact of gravitational force on the vehicle, which affects lateral acceleration measurements. Thus, when lateral acceleration is used for curvature estimation, road camber can increase lateral offsets and reduce the accuracy of curvature estimations.

ADAS lateral feature performance, such as for the lane centering assist feature, a lane change assist feature, and/or an evasive maneuvering assist feature, may be influenced by inputs from the surroundings and vehicle state information or signals. Curvature of the vehicle may be determined using techniques including yaw rate, steering angle, Ackermann steering angle, and/or lateral acceleration-based curvature estimation techniques. When the road profile has no grade or camber, and no wind is present, the lateral acceleration and the Ackermann steering angle-based technique may produce better curvature estimation than the yaw rate and the steering angle-based techniques.

When the road is graded, the Ackermann steering angle-based technique may produce better curvature estimation than the yaw rate, the steering angle, and the lateral acceleration-based techniques. Similarly, when the road is cambered, the Ackermann steering angle-based technique may produce better curvature estimation than the yaw rate and the steering-based techniques, and the lateral acceleration-based estimation may provide the least accurate curvature estimation. In high wind conditions, the yaw rate and the lateral acceleration-based techniques may produce better curvature estimation than the Ackermann steering angle-based estimation. However, the Ackermann steering-angle based estimation may produce satisfactory curvature estimations for application in a vehicle. The steering-based technique may provide the least accurate curvature estimations in high wind conditions. When road grade, road camber, and high winds are combined, the Ackermann steering angle-based technique may produce the most accurate curvature estimation, followed by the yaw rate-based estimation technique, and the steering angle and the lateral acceleration-based techniques may produce the least accurate curvature estimation.

The curvature estimation techniques described herein may also produce a lateral offset from the lane center. When the road profile has no grade or camber, and no wind is present, the lateral acceleration-based technique may yield the lowest lateral offset in steady state road curvature, while the Ackermann steering angle-based technique may yield the lowest lateral offset in a transient road curvature. When road grade is introduced, the yaw rate and the lateral acceleration-based techniques may result in the lowest lateral offset in the steady state, and the Ackermann steering angle-based technique may yield the lowest lateral offset in the transient state.

With the introduction of road camber, the yaw rate-based technique may produce the lowest lateral offset in the steady state, and the Ackermann steering angle-based technique may yield the lowest lateral offset in the transient states. When high winds are introduced, the yaw rate and the lateral acceleration-based techniques may produce the lowest lateral offset in both steady and transient conditions. When road grade, road camber, and high winds are combined, the yaw rate and the lateral acceleration-based techniques may yield the lowest lateral offset. Thus, the optimal curvature estimation technique may depend on the specific driving conditions and variations encountered by the equipped vehicle.

The lane centering feature relies on the accurate estimation of the actual curvature (k) of the equipped vehicle. Curvature estimation may be based on yaw rate, steering angle, and/or lateral acceleration. Road conditions and environmental factors such as road grade, road camber, and wind, along with the chosen estimation techniques, may lead to varying lateral offsets from the lane center, significantly impacting overall system performance.

The particular curvature estimation technique directly influences the effectiveness of lateral control features. Therefore, it may be advantageous to combine techniques that adapt to varying driving conditions, enhancing both accuracy and reliability in curvature estimation for improved performance of the lane centering feature. For example, the ADAS may selectively utilize the most effective curvature estimation technique based on road conditions and environmental conditions surrounding the vehicle. Additionally or alternatively, lane centering algorithms that are less dependent on curvature or error management in curvature estimation may be incorporated, allowing for better adaptation to road and environmental variations.

The system may utilize aspects of the systems described in U.S. patent application Ser. No. 19/299,402, filed Aug. 14, 2025 (Attorney Docket MAG04 P5447), U.S. patent application Ser. No. 19/299,401, filed Aug. 14, 2025 (Attorney Docket MAG04 P5446), and/or U.S. patent application Ser. No. 19/295,798, filed Aug. 11, 2025 (Attorney Docket MAG04 P5444), and/or U.S. provisional application Ser. No. 63/706,146, filed Oct. 11, 2024, which are all hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a camera disposed at a vehicle equipped with the vehicular driving assist system and viewing at least forward of the equipped vehicle, wherein the camera is operable to capture image data;
an electronic control unit (ECU) comprising electronic circuitry and associated software;
wherein image data captured by the camera is transferred to the ECU;
wherein the electronic circuitry of the ECU comprises an image processor, and wherein the image processor is operable to process image data captured by the camera and transferred to the ECU;
wherein the vehicular driving assist system, at least in part via processing at the ECU of image data captured by the camera and transferred to the ECU, determines a target path of travel ahead of the equipped vehicle along a road on which the equipped vehicle is traveling;
wherein the vehicular driving assist system determines vehicle state information from a respective vehicle state source of a plurality of vehicle state sources of the equipped vehicle based at least in part on a current environmental condition at the equipped vehicle; and
wherein the vehicular driving assist system estimates curvature of a current trajectory of travel of the equipped vehicle based at least in part on the determined vehicle state information.

2. The vehicular driving assist system of claim 1, wherein the vehicular driving assist system controls steering of the equipped vehicle based at least in part on (i) the determined target path of travel and (ii) the estimated curvature of the current trajectory of travel of the equipped vehicle to maneuver the equipped vehicle along the determined target path of travel.

3. The vehicular driving assist system of claim 1, wherein the determined vehicle state information comprises at least one selected from the group consisting of (i) yaw rate of the equipped vehicle, (ii) steering angle of the equipped vehicle and (iii) lateral acceleration of the equipped vehicle.

4. The vehicular driving assist system of claim 1, wherein the current environmental condition comprises at least one selected from the group consisting of (i) grade of the road on which the equipped vehicle is traveling, (ii) camber of the road on which the equipped vehicle is traveling and (iii) wind conditions at the equipped vehicle.

5. The vehicular driving assist system of claim 1, wherein the determined vehicle state information comprises at least one selected from the group consisting of (i) wheel speeds of individual wheels of the equipped vehicle and (ii) GPS data.

6. The vehicular driving assist system of claim 1, wherein the vehicular driving assist system comprises a lane centering assist system of the equipped vehicle, and wherein the target path of travel is along the center of a traffic lane of the road on which the equipped vehicle is traveling.

7. The vehicular driving assist system of claim 1, wherein the vehicular driving assist system comprises a lane change assist system of the equipped vehicle, and wherein the target path of travel is partially along the center of an adjacent traffic lane of the road on which the equipped vehicle is traveling, and wherein the adjacent traffic lane is adjacent to a traffic lane of the road on which the equipped vehicle is traveling.

8. The vehicular driving assist system of claim 1, wherein the target path of travel includes a target position for evasive maneuvering assist of the equipped vehicle.

9. The vehicular driving assist system of claim 1, wherein the vehicular driving assist system estimates the curvature of the current trajectory of travel of the equipped vehicle based on a kinematic bicycle model.

10. The vehicular driving assist system of claim 1, wherein the vehicular driving assist system estimates the curvature of the current trajectory of travel of the equipped vehicle based on an Ackermann steering model.

11. The vehicular driving assist system of claim 1, wherein the vehicular driving assist system comprises a proportional-integral-derivative (PID) controller to correct error in the estimated curvature of the current trajectory of travel of the equipped vehicle.

12. The vehicular driving assist system of claim 1, wherein the vehicular driving assist system determines the target path of travel based on one or more higher-order polynomial trajectories.

13. The vehicular driving assist system of claim 1, wherein the estimated curvature is determined based at least in part on a look-ahead time, and wherein the look-ahead time approximates a delay between the target path of travel and steering control of the equipped vehicle.

14. A vehicular driving assist system, the vehicular driving assist system comprising:
a camera disposed at a vehicle equipped with the vehicular driving assist system and viewing at least forward of the equipped vehicle, wherein the camera is operable to capture image data;
an electronic control unit (ECU) comprising electronic circuitry and associated software;
wherein image data captured by the camera is transferred to the ECU;
wherein the electronic circuitry of the ECU comprises an image processor, and wherein the image processor is operable to process image data captured by the camera and transferred to the ECU;
wherein the vehicular driving assist system, at least in part via processing at the ECU of image data captured by the camera and transferred to the ECU, determines a target path of travel ahead of the equipped vehicle along a road on which the equipped vehicle is traveling;
wherein the vehicular driving assist system determines vehicle state information from a respective vehicle state source of a plurality of vehicle state sources of the equipped vehicle based at least in part on a current environmental condition at the equipped vehicle;
wherein the determined vehicle state information comprises at least one selected from the group consisting of (i) yaw rate of the equipped vehicle, (ii) steering angle of the equipped vehicle and (iii) lateral acceleration of the equipped vehicle;
wherein the current environmental condition comprises at least one selected from the group consisting of (i) grade of the road on which the equipped vehicle is traveling, (ii) camber of the road on which the equipped vehicle is traveling and (iii) wind conditions at the equipped vehicle;
wherein the vehicular driving assist system estimates curvature of a current trajectory of travel of the equipped vehicle based at least in part on the determined vehicle state information; and
wherein the vehicular driving assist system controls steering of the equipped vehicle based at least in part on (i) the determined target path of travel and (ii) the estimated curvature of the current trajectory of travel of the equipped vehicle to maneuver the equipped vehicle along the determined target path of travel.

15. The vehicular driving assist system of claim 14, wherein the vehicular driving assist system comprises a lane change assist system of the equipped vehicle, and wherein the target path of travel is partially along the center of an adjacent traffic lane of the road on which the equipped vehicle is traveling, and wherein the adjacent traffic lane is adjacent to a traffic lane of the road on which the equipped vehicle is traveling.

16. The vehicular driving assist system of claim 14, wherein the target path of travel includes a target position for evasive maneuvering assist of the equipped vehicle.

17. The vehicular driving assist system of claim 14, wherein the estimated curvature is determined based at least in part on a look-ahead time, and wherein the look-ahead time approximates a delay between the target path of travel and steering control of the equipped vehicle.

18. A vehicular driving assist system, the vehicular driving assist system comprising:
a camera disposed at a vehicle equipped with the vehicular driving assist system and viewing at least forward of the equipped vehicle, wherein the camera is operable to capture image data;
an electronic control unit (ECU) comprising electronic circuitry and associated software;
wherein image data captured by the camera is transferred to the ECU;
wherein the electronic circuitry of the ECU comprises an image processor, and wherein the image processor is operable to process image data captured by the camera and transferred to the ECU;
wherein the vehicular driving assist system comprises a lane centering assist system of the equipped vehicle;
wherein the vehicular driving assist system, at least in part via processing at the ECU of image data captured by the camera and transferred to the ECU, determines a target path of travel ahead of the equipped vehicle along the center of a traffic lane of a road on which the equipped vehicle is traveling;
wherein the vehicular driving assist system determines vehicle state information from a respective vehicle state source of a plurality of vehicle state sources of the equipped vehicle based at least in part on a current environmental condition at the equipped vehicle;
wherein the vehicular driving assist system estimates curvature of a current trajectory of travel of the equipped vehicle based at least in part on the determined vehicle state information;
wherein the vehicular driving assist system controls steering of the equipped vehicle based at least in part on (i) the determined target path of travel and (ii) the estimated curvature of the current trajectory of travel of the equipped vehicle to maneuver the equipped vehicle along the determined target path of travel; and
wherein the vehicular driving assist system comprises a proportional-integral-derivative (PID) controller to correct error in the estimated curvature of the current trajectory of travel of the equipped vehicle.

19. The vehicular driving assist system of claim 18, wherein the vehicular driving assist system estimates the curvature of the current trajectory of travel of the equipped vehicle based on an Ackermann steering model.

20. The vehicular driving assist system of claim 18, wherein the determined vehicle state information comprises at least one selected from the group consisting of (i) yaw rate of the equipped vehicle, (ii) steering angle of the equipped vehicle, (iii) lateral acceleration of the equipped vehicle, (iv) wheel speeds of individual wheels of the equipped vehicle and (v) GPS data; and
wherein the current environmental condition comprises at least one selected from the group consisting of (i) grade of the road on which the equipped vehicle is traveling, (ii) camber of the road on which the equipped vehicle is traveling and (iii) wind conditions at the equipped vehicle.
